(19) United States
(12) Patent Application Publication
(10) Pub. No.: US 2019/0366578 A1
(43) Pub. Date: Dec. 5, 2019

(54) Holder Assembly for a Circular Saw Tool

(71) Applicants: Robert Bosch GmbH, Stuttgart (DE); Bosch Limited, Bangalore (IN)

(72) Inventor: Dhananjay Raghunath Zinge, Maharashtra (IN)

(21) Appl. No.: 16/423,401

(22) Filed: May 28, 2019

(30) Foreign Application Priority Data
May 31, 2018 (IN) 201841020446

(51) Int. Cl. B27B 5/32; B24B 45/00

(52) U.S. Cl. CPC B27B 5/32; B27B 5/38; B24B 45/006

(57) ABSTRACT

A holder assembly for a circular saw tool includes a blade having a bore. The blade is mountable to a free end of a rotatable shaft or of the tool through the bore. The blade is further adapted to be held in a pressing manner between an inner flange and an outer flange on the shaft. The holder assembly is comprised of at least one depression formed on a circumferential surface of the free end of the shaft, and at least one clutch member (or dogs) paired and mounted about the at least one depression, and located between the bore of the blade and the shaft. The holder assembly provides improved gripping while safety or emergency braking.

### FIELD OF THE INVENTION

The present invention relates to a holder assembly for a circular saw tool.

### BACKGROUND OF THE INVENTION

According to a prior art US 2010/0040474, a fixing device for rotary blade is provided. A fixing device for fixing a rotary blade to a spindle in a bench circular saw, for example, has a structure in which it is difficult to achieve structural compactification in radial size. Therefore, there has been a problem of sacrificing an inclination angle and a cutting depth of the rotary blade. Provided is a fixing device free from such problems owing to employment of a structure which can be easily compactified in a radial direction. Cam portions are provided on respective surfaces opposite to each other of an intermediate flange and an outer flange so as to mesh with each other. The cam portions slide with each other with a rotational force imparted to the rotary blade so that the rotational force is converted into a displacement in a direction of an axis of the intermediate flange and is applied in a direction of clamping the rotary blade.

### BRIEF DESCRIPTION OF THE ACCOMPANYING DRAWINGS

An embodiment of the disclosure is described with reference to the following accompanying drawings,

FIG. 1 illustrates a side cross-section view of the holder assembly, according to an embodiment of the present invention.

FIG. 2 illustrates an exploded view of a holder assembly for a circular saw tool, according to an embodiment of the present invention;

FIG. 3 illustrates a detailed view of a free end of the shaft, according to an embodiment of the present invention, and

FIG. 4 illustrates a front cross-section view of the holder assembly, according to an embodiment of the present invention.

### DETAILED DESCRIPTION OF THE EMBODIMENTS

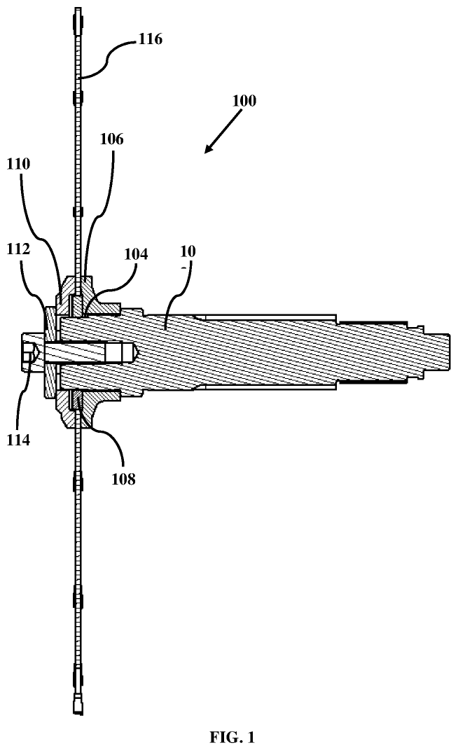

FIG. 1 illustrates a side cross-section view of the holder assembly, according to an embodiment of the present invention. The holder assembly 100 for the circular saw tool, comprises a blade 116 having a bore. The blade 116 is mountable to a free end of a rotatable shaft 102 or a spindle of the tool through the bore. The blade 116 is further adapted to be held in a pressing manner between an inner flange 106 and an outer flange 110 on the shaft 102. The holder assembly 100 is characterized by at least one depression 104 formed on a circumferential surface of the free end of the shaft 102, and at least one clutch member 108 (or dogs) paired and mounted about the at least one depression 104, and located between the bore of the blade 116 and the shaft 102. The depression 104 may also be referred to as profile.

The blade 116 is mounted over the at least one clutch member 108 and then held between the inner flange 106 and the outer flange 110 with the help of a washer 112 and a bolt 114.

The at least one clutch member 108 is adapted to brake rotation of the blade 116 under emergency conditions. One of the emergency condition may be presence of a body part of a human operator in proximity or in contact with the rotating blade 116. The braking or stopping of the rotation of the shaft 102, under emergency conditions is performed by separate devices or systems known in the art.

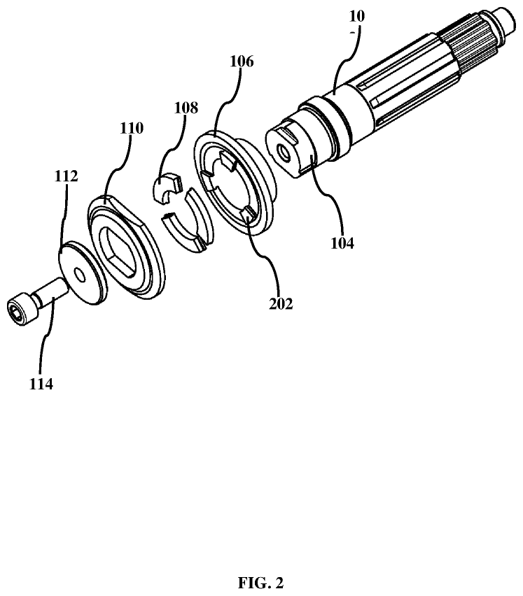

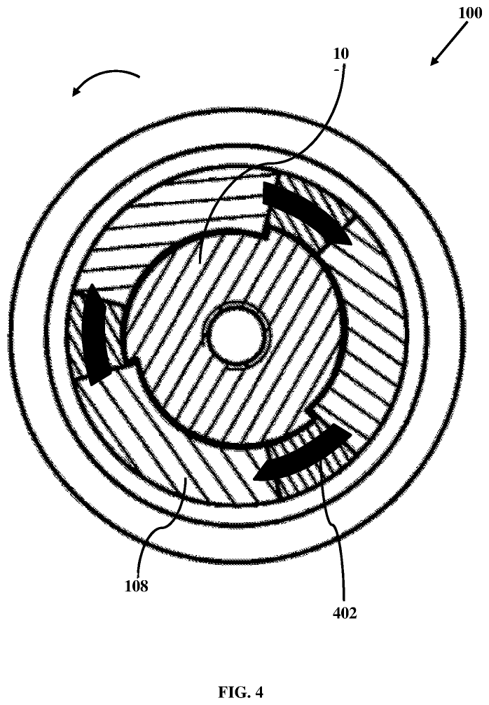

FIG. 2 illustrates an exploded view of a holder assembly for a circular saw tool, according to an embodiment of the present invention. The at least one clutch member 108 comprises two clutch members 108 paired and mounted about respective two depressions 104. At least two restraining elements 402 (shown in FIG. 4) are adapted to connect and hold the two clutch members 108 to the shaft 102. The restraining elements 402 are selected from a group comprising a leaf spring and a torsional spring. The restraining elements 402 are optional.

In accordance to another embodiment of the present invention, at least one clutch member 108 comprises three clutch members 108, paired and mounted about respective three depressions 104 as shown in FIG. 2. Further, at least three restraining elements 402 are adapted to connect and hold the three clutch members 108 to the shaft 102. The restraining elements 402 are selected from a group comprising a leaf spring and a torsional spring. The restraining elements 402 are optional.

Further, the inner flange 106 comprises at least one protrusion 202 acting as guide to position the at least one clutch member 108. The guide assist in placement of the at least one clutch member 108 in a fitting manner. In FIG. 2, three clutch members 108 are arranged between the three protrusions 202.

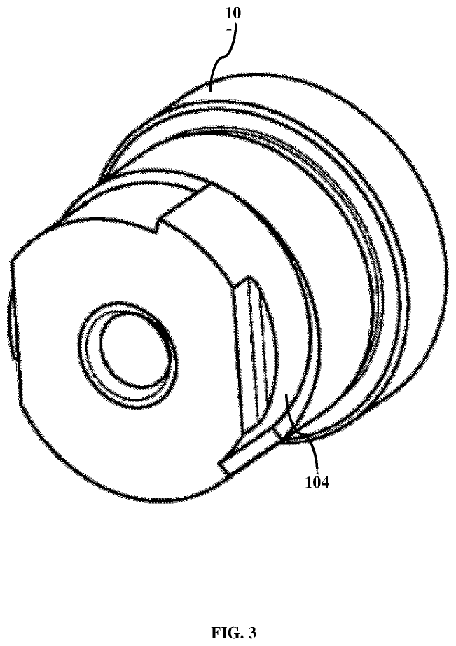

FIG. 3 illustrates a detailed view of a free end of the shaft, according to an embodiment of the present invention. The depression 104 for mounting the clutch member 108 is shown. The number of depressions 104 are equal to the number of clutch members 108 used. The depression 104 is in the form of curve with decreasing radius. Similarly, the at least one clutch member 108 is so designed that on pairing with the depression 104, the circumference of the at least one clutch member 108 forms a circle. The shaft 102 comprises an axial bore to accept the bolt 114 for firm attachment.

The circular saw tool is selected from a group comprising a table-top tool, a portable tool, a hand-held tool, a plunge tool and the like. In an embodiment, the holder assembly 100 is retrofit to existing circular saw tools.

FIG. 4 illustrates a front cross-section view of the holder assembly, according to an embodiment of the present invention. The at least one clutch member 108 is in the form of a sector of a circle with varying radius, so as to match with the depression 104. The three clutch members 108 are held by the three restraining element 402.

A working of the holder assembly according to the present invention is disclosed. When the circular saw tool is in operation, the complete holder assembly 100 is rotates. When the shaft 102 stops suddenly with external mechanism called brake, the blade 116 tends to rotate due to inertia as it is held in place with inner flange 106 and the outer flange 110. The sub-assembly of the blade 116, the inner flange 106 along with the clutch member 108 tends to rotates due to the inertia of the blade 116. As the clutch member 108 rotates on the shaft 102 due to motion input form the inner flange 106, the clutch members 108 tends to move radially out and grips internal surface of the blade 116 by harder gripping force as blade 116 tends to rotate further. The gripping enhances as the clutch member 108 move on the depression 104 or profile of the shaft 102. Hence, the mechanism converts moment of inertia of the blade 116 into higher gripping of the blade 116 during deceleration. As the blade 116 stops, the gripping force tends to reduce as the clutch member 108 held in place with the restraining element 402.

In accordance to an embodiment of the present invention, the holder assembly 100 provides improved gripping while safety or emergency braking with easy access to the blade 116 and also reduces efforts for changing the blade 116. Further, the mounting and demounting torque required for the blade 116 is within normal human limit. The holder assembly 100, enhances safety braking mechanism by hard gripping blade 116 at braking event. Also, the temperature of blade 116 does not rise as the rotation of the blade 116 is stopped instantly.

It should be understood that embodiments explained in the description above are only illustrative and do not limit the scope of this invention. Many such embodiments and other modifications and changes in the embodiment explained in the description are envisaged. The scope of the invention is only limited by the scope of the claims.

1. A holder assembly for a circular saw tool, comprising:
a blade having a bore, said blade mountable to a free end of a rotatable shaft of said tool through said bore, said blade is further adapted to be held in a pressing manner between an inner flange and an outer flange on said shaft, wherein:
at least one depression is formed on a circumferential surface of said free end of said shaft, and
at least one clutch member is paired and mounted about said at least one depression, and located between said bore of said blade and said shaft.

2. The holder assembly as claimed in claim 1, wherein said at least one clutch member is adapted to brake rotation of said blade under emergency conditions.

3. The holder assembly as claimed in claim 1, wherein said at least one clutch member comprises two clutch members paired and mounted about two depressions.

4. The holder assembly as claimed in claim 3, wherein at least two restraining elements are adapted to connect and hold said two clutch members to said shaft.

5. The holder assembly as claimed in claim 4, wherein said restraining elements are selected from a group comprising a leaf spring and a torsional spring.

6. The holder assembly as claimed in claim 1, wherein said at least one clutch member comprises three clutch members, paired and mounted about three depressions.

7. The holder assembly as claimed in claim 6, wherein said at least three restraining elements are adapted to connect and hold said three clutch members to said shaft.

8. The holder assembly as claimed in claim 7, wherein said restraining elements are selected from a group comprising a leaf spring and a torsional spring.

9. The holder assembly as claimed in claim 1, wherein said circular saw tool is selected from a group comprising a table-top tool, a portable tool, a hand-held tool, and a plunge tool.

10. The holder assembly as claimed in claim 1, wherein the holder assembly is retrofit to existing circular saw tools.
